(19) United States
(12) Patent Application Publication
(10) Pub. No.: US 2009/0022430 A1
(43) Pub. Date: Jan. 22, 2009

(54) BAG WITH HANDLE AND METHOD OF MANUFACTURE THEREOF

(75) Inventors: Brian George Hutchison, Brampton (CA); William Troost, Toronto (CA)

Correspondence Address: STUART WILKINSON, 833 CALDER ROAD, MISSISSAUGA, ON, L5J 2N6, CA

(73) Assignee: Peel Plastic Products Ltd., Brampton (CA)

(21) Appl. No.: 12/202,502

(22) Filed: Sep. 2, 2008

(51) Int. Cl. B65D 33/06; B23P 19/04

(52) U.S. Cl. 383/9; 29/700

(57) ABSTRACT

A bag includes a panel having an inner surface and an outer surface and holes through the panel. A handle strip having a handle part is disposed adjacent the panel outer face, and a reinforcing strip, which can be separate from or an extension to the handle strip, is disposed adjacent the panel inner face. An area of the reinforcing strip is sealed to an area of the handle strip at the hole and is sealed also to the inner face of the panel. In a method of manufacturing the bag and handle arrangement, holes are formed in a bag panel, a handle strip has its end regions threaded through the holes and the end regions are folded back and sealed against each other and against a reverse face of the bag pattern piece

### TECHNICAL FIELD OF THE INVENTION

The present invention relates to a bag having a carrying handle and extends to a method of manufacturing such a bag. The invention has particular application to plastic bags.

### DESCRIPTION OF RELATED ART

Plastic bags are a ubiquitous and highly practical mode of carrying things and there is a whole panoply of shapes and structures of such bags depending on the particular function of the bag. Many bags have handles of some kind or other. These may be merely formations in the material of the bag or may include additional elements which are attached to the main carcase of the bag and which provide added strength and convenience.

United States patent application 20060188178 describes a packaging container made of plastic film having a strap handle fixed into the container wall. The container wall has an inner side and the strap handle is arranged on the inner side. The container wall has an access opening through which the strap handle is accessible from the exterior of the container. A support patch made of plastic film is connected to the container wall and closes off the access opening relative to the interior of the container.

While this arrangement offers value, further improvements are possible to improve the performance and manufacturability of bags having associated handles. Limitations and disadvantages of conventional and traditional approaches to bag-with-handle designs and manufacture thereof will become apparent to one of ordinary skill in the art through comparison of such bag and handle arrangements with the present invention.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIGS. 1-3 show front and side views of a pouch bag according to an embodiment of the invention.

FIG. 4 is a longitudinal sectional view of a bag handle arrangement according to an embodiment of the invention.

FIG. 5 is a plan view of the bag handle arrangement of FIG. 4.

FIG. 6 is a longitudinal sectional view of a bag handle arrangement according to another embodiment of the invention.

FIG. 7 is a plan view of the bag handle arrangement of FIG. 6.

FIG. 8 is a longitudinal sectional view of a bag handle arrangement according to a further embodiment of the invention.

FIG. 9 is a plan view of the bag handle arrangement of FIG. 8.

FIG. 10 shows part of a web of thermoplastics film used in the manufacture of a bag according to an embodiment of the invention.

FIG. 11 shows part of a web of thermoplastics film used in a bag and handle manufacturing method according to an embodiment of the invention.

FIG. 12 shows part of a web of thermoplastics film used in another bag and handle manufacturing method according to an embodiment of the invention.

FIG. 13 is a section through apparatus used in a bag and handle manufacturing method according to an embodiment of the invention.

### DETAILED DESCRIPTION OF THE INVENTION INCLUDING THE PRESENTLY PREFERRED EMBODIMENTS

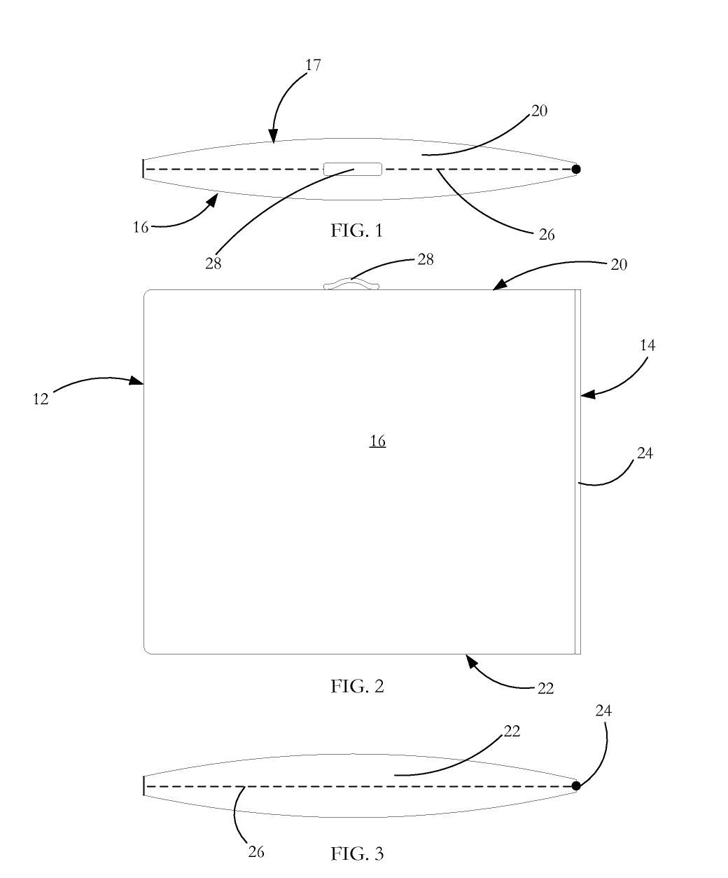

Referring to FIGS. 1 to 3, a bag according to one embodiment of the invention is of a pouch form having opposed ends 12, 14, front and back panels 16, 17, and opposed side panels 20, 22. The end 14 of the bag has a press-to-close zipper arrangement 24 which enables opening and closing of the end 14 although the end 14 can alternatively be sealed during manufacture if the bag is to be filled from the end 12. The press-to-close zipper arrangement can alternatively be another form of closure such as a slider zipper arrangement. The end 12 is left open to allow for later filling and then sealing or is sealed off during manufacture if the bag is to be filled from the end 14. The side panels 20, 22 each provide a gusset region by being folded along their length as shown at 26. It will be understood that the pouch bag is just one form of bag structure in which the invention can be embodied. Bags having other shapes, closures, folds, reinforcements, gussets, materials, etc., can all use the principles of the invention.

The side panel 20 has a handle 28 attached to it to allow the bag to be carried in one hand like a briefcase or suitcase. As shown in longitudinal section in FIG. 4 and in plan view in FIG. 5, the handle 28 forms part of a handle strip 30 and lies adjacent an outer face 32 of the side panel 20. The side panel 20 has a pair of circular holes 34 through which project end regions of the handle strip 30 so that parts 36 of the end regions contact parts of an inner face 40 of the side panel bounding the holes 34. As shown in FIG. 5, the handle strip 30 has locations 42 of reduced width where the end regions extend through the holes 34, the width of the handle strip at the reduced width locations matching the width of the circular holes 34. The end regions have parts 44 which are folded over onto, and sealed against, respective parts 36 at the holes 34. In addition, marginal areas 46 of the folded over parts 44 contact and are sealed against areas of the inner face 40 bounding the holes 34. The sealing zones in this and subsequent FIGs. are shown as cross-hatched areas. The arrangement is such that the folded parts 36, 44 at each hole provide locally thicker and stronger reinforcing strips where the handle strip joins the side panel 20. The folded over parts also act to seal the holes 34 against entry of contaminants from outside the bag and from escape of contents from within the bag, these being particularly important if the bag is to carry foodstuffs. Obviously, if sealing is not important, then the handle can be attached to the bag in a non-sealing arrangement provided that the strength of the handle anchor region is not compromised.

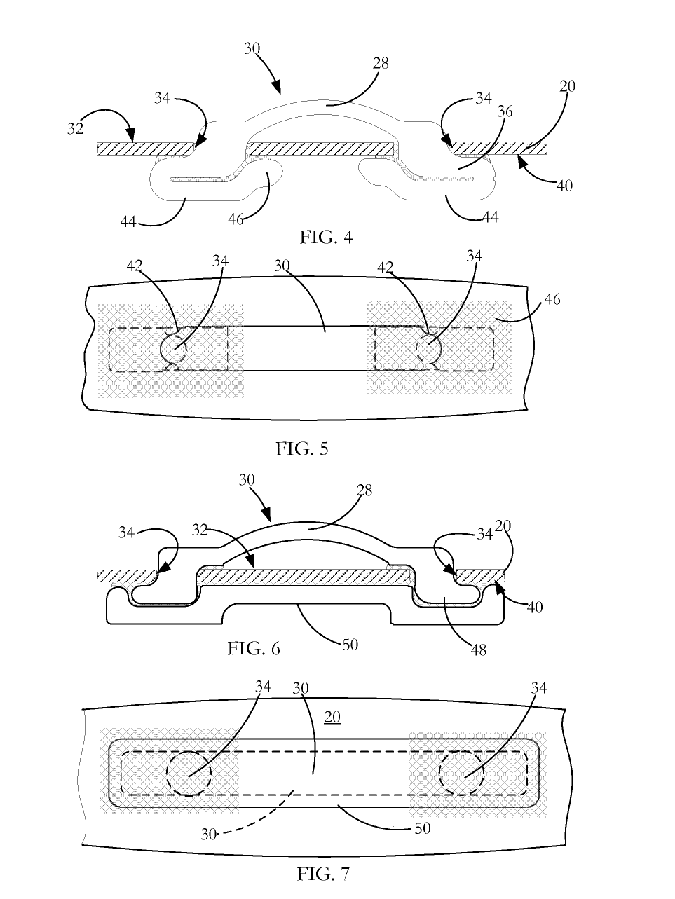

Referring to FIGS. 6 and 7, an alternative embodiment of the invention is shown using a pouch bag similar to that shown in FIGS. 1 to 3. As in the FIG. 4 embodiment, handle 28 forms part of a handle strip 30 and lies adjacent an outer face 32 of the side panel 20. The side panel has a pair of circular holes 34 through which project end regions 48 of the handle strip 30 so that the end regions contact an inner face 40 of the side panel. In contrast with the embodiment of FIGS. 4 and 5, a reinforcing strip 50 is not formed as extensions of the handle strip, but is instead a completely separate element located on the inside of the side panel 20. Areas of the handle strip end regions and areas of the reinforcing strip 50 are sealed together through the holes 34. Reinforcing strip 50 is wider than the handle strip end regions and the sealing zone is made larger than the holes 34 so that marginal areas of the handle strip end regions and of the reinforcing strip are sealed to each other and to areas of the inner face 40.

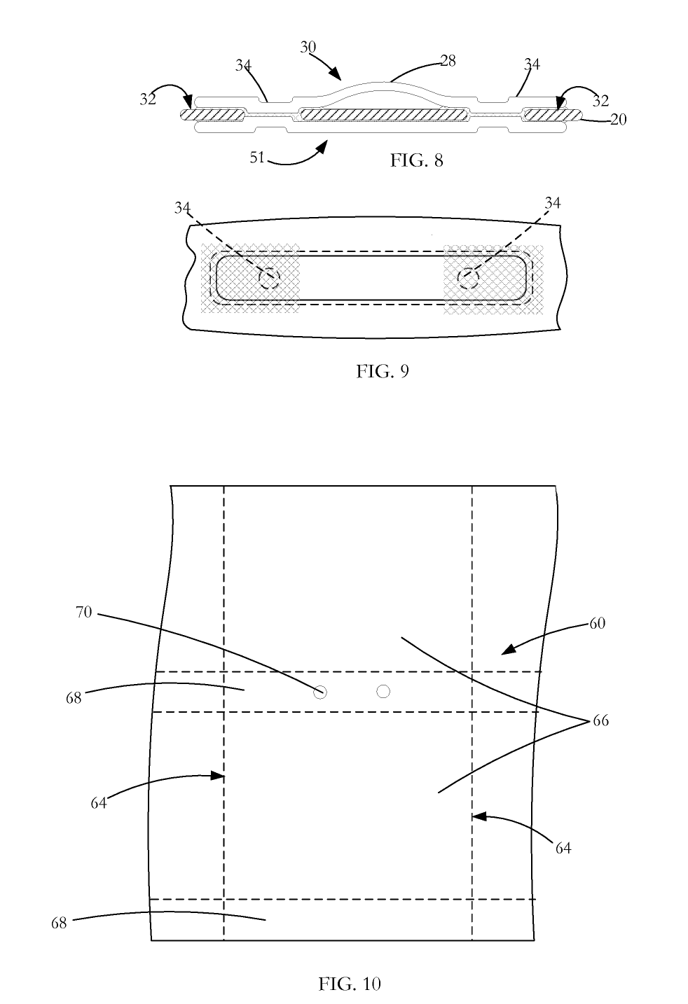

Referring to FIGS. 8 and 9, a further embodiment of the invention is shown using a pouch bag similar to that shown in FIGS. 1 to 3. In this embodiment, a handle strip has a handle part and end regions. The handle strip is located completely on one side of a side panel 20, adjacent its outer face 32. A reinforcing strip 51 is located on the other side of the side panel 20 adjacent its inner face. As in the FIG. 4, embodiment, the side panel 20 has a pair of circular holes which are covered by areas of the handle strip 30 and the reinforcing strip 51 with the handle strip and the reinforcing strip being sealed together through the holes. The sealing zones are made larger than the holes so that areas of the reinforcing strip surrounding the holes are sealed to the inner face of the side panel 20.

In each of the embodiments of the invention described, the bag, the handle strip and the reinforcing strip are formed from heat-sealable thermoplastics film materials and sealing is effected by heat sealing. Such materials include, by way of example and not limitation, polyolefins such as polyethylene and polypropylene, polyesters, vinyl polymers, and the like. The materials may be low-, medium- or high-density polymers and may be single or multi-layer composite material. Composite laminated materials may include adhesive layers. Suitable materials for adhesive or tie layers are adhesive resins such as Mitsui Petrochemical's ADMER®). Sealing resins such as ethylene vinyl acetate may be used to improve sealing of certain polymer layers and the use of such sealing resins may obviate the use of adhesive tie layers. The invention contemplates the use of thermoplastics films which are made of, or which include, a barrier sheet material such as, for example, EVOH which provides a barrier generally preventing the transmission of gases.

The thickness of the film material is selected mainly on the basis of the intended weight the bag must carry and generally ranges from about 2 to 20 mils.

While thermoplastics film is preferred as a construction material, the invention is also applicable to bags formed of other sheet materials such as stiff paper or card and to other sheet or foil materials. The type of thermoplastics or other sheet material used will depend on the purposes to which the bag is to be put, whether it is easy to handle in manufacturing, whether it can be readily printed upon, whether it is waterproof, whether it is strong enough to resist tearing or bulging, etc.

In one example, the film material of the handle strip and the reinforcing strip are formed from two layers of a composite sheet of coextruded, alternating layers of thermoplastics and adhesive in the following order: 1.75-1.9 mils polyethylene, 0.35-0.5 mils adhesive polymer, 0.5 mils nylon, 0.35-0.5 mils adhesive polymer, 1.75-1.9 mils polyethylene. This composite sheet can be bought from a number of extrusion companies, including the Pliant Corporation. The handle can be made by laminating together two layers of the composite sheet described above using an adhesive that may be solvent based or solvent-less (i.e. 100% solids). The strips can be formed from other film material depending on the particular properties required of the handle and the reinforcement from the viewpoint of the bag function and its manufacturability. An alternative composite structure thermoplastics has a multi-ply layered material with outer layers of polyethylene and a core layer of nylon. The particular selection of ply materials and the number of layers of each material is chosen for the particular properties desired in the bag. Thus, polyethylene has good heat sealing properties and relatively high strength. A copolymer polyethylene with high elastomeric content can be used where a soft handle is required. The material of both the handle strip and the reinforcing strip is selected to achieve required reinforcing action where the handle strip is anchored to a bag panel. For example, thermoplastic films can be used which have been oriented during manufacture to impart particular mechanical strength along the line of the handle or at other critical stress sites. Such oriented strength can be imparted, as is known, by for example stretching at ambient temperatures, melt orienting during extrusion, etc.

Heat sealing and bonding of layers of sheet material is effected by the application of temperature and pressure for a predetermined time at locations where the layers are to be heat sealed. The particular temperature, pressure and time are selected based on the particular nature of the sheet materials being bonded together. Bonding is typically effected at multiple bonding stations, with the bonded material subsequently being cooled. For materials such as stiff paper or card which cannot be heat sealed, an adhesive is used at the contact zones between the handle strip and the reinforcing strip, with adhesive being used also where the reinforcing strip and the handle strip, other than the handle part, contact the surfaces of the panel within which the handle is anchored.

It will be appreciated that many variations are possible in the design of a bag and handle arrangement using the principles of the invention. For example, a circular shape is used for the holes 34 because this shape acts to distributes forces around the edge of the holes when the bag is lifted by the handle and so reduces the chance of the bag or handle material tearing. However, other shapes can be utilized depending on the properties required at the joint between the handle strip 30 and the reinforcing strip and the relationship of that joint with the bag panel in which the joint is located. Thus, the holes can be of oval, slot, D or other suitable form.

In addition, although the preferred embodiments have two spaced holes, more that two holes can be used with the handle strip and the reinforcing strip sealed together at some or all of the holes. In a further alternative, a multiplicity of small perforations is made in the bag panel so that the handle strip and the reinforcing strip at each contact site are sealed together effectively through a grid or lattice portion of the bag panel.

A method of manufacturing a bag and handle arrangement according to one embodiment of the invention will now be described, the manufacturing method having particular application to the embodiment of bag illustrated in FIGS. 4 and 5. As shown in FIG. 10, bag web 60 of thermoplastic film material is unrolled from a stock roll and is driven around rollers (not shown) through a plurality of stations in which any of a number of operations is performed. These can include any or all of (a) folding, (b) cutting, (c) punching, (d) forming or adding gusset pieces, (e) forming or adding reinforcing areas, (f) application of adhesive (g) heat sealing, (h) cooling, (i) fitting elements of a press-to-close or other fastener, etc.

The bag web 60 shown is suitable for forming a pouch bag of the form shown in FIGS. 1 to 3, and, as shown in broken line, has areas 66 which are to become the bag front and back panels, and areas 68 which are to become the opposed side panels of the bag, the side panels also to form gusset regions in the completed bag. Typically, for a pouch bag of the sort illustrated in FIG. 4, gusset areas are formed in the sides of the pouch bag, one end is either left open for later filling or is sealed shut, and the other end is fitted with a closure arrangement such as a push-to-close or a slider arrangement. Details of the manufacturing process to the extent they relate to such steps form no part of the invention and will not be described in detail. It will be understood that the pouch bag is just one form of bag that can be made by a manufacturing method according to the invention. Bags having other shapes, panels, closures, gussets, materials, etc., can be manufactured using the method of the invention to be described presently with appropriate modifications depending on the particular form of bag being made.

In the preparation of a bag with handle arrangement according to one embodiment of the invention, and as illustrated in FIG. 10, the continuous bag web 60 is driven through a punching station where it is halted momentarily and pairs of holes 70 are punched into it. As shown, the holes are punched into a part of the bag which is intended to function as a side panel gusset. The holes are circular, although as previously indicated, depending on the properties required of the handle, such as its strength, resistance to tearing, etc., the holes can be made in different shapes.

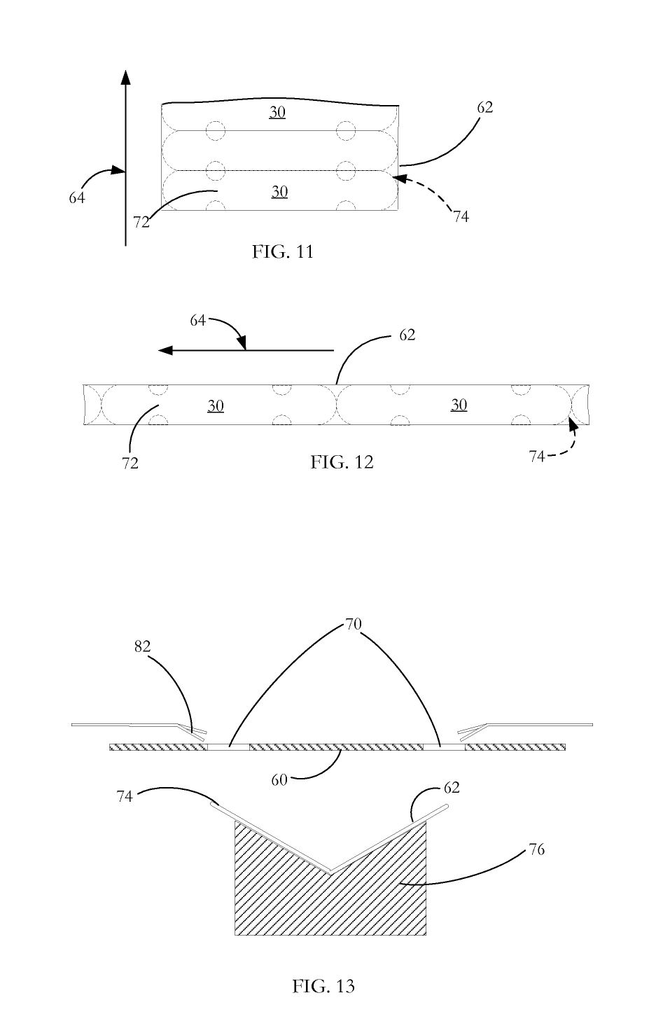

Referring to FIGS. 11 and 12, a continuous web of handle strip material 62 is also unrolled from a stock roll. The web of handle strip material is used to form a series of handle strips as shown in outline (broken line) in FIG. 11 for side delivery and FIG. 12 for end delivery, as shown by arrow 64. The handle strip web is driven around rollers (not shown) to a punching station at which semicircular cut-outs are punched from the web to form regions 72 of reduced width. The width of each region 72 is made the same as the diameter of the holes 70 in the bag web to aid in subsequent threading and autolocation steps as will be described presently. The handle strips are formed with rounded end portions 74 although alternative end shapes are possible.

The bag web 60 and the handle strip web 62 are then fed to a threading station where the webs are momentarily halted to allow a handle strip 30 to be separated from the handle strip web 62 and to be attached to a suspended part of the bag web 60. In one embodiment, a separated handle strip is delivered from the side as shown in FIG. 11. As shown in FIG. 13, the handle strip 62 is laid up in a bent configuration against a transfer head 76. The handle strip is held in position by a vacuum applied at the transfer head 76, the transfer head being shaped and dimensioned such that end regions 74 of the handle strip are curled and project freely beyond the transfer head. The transfer head is moved towards the suspended bag web 60 so that the handle strip end regions 74 are inserted through the holes 70. Retractable gripping heads 82 open as the end portions 74 of the handle pattern piece are inserted through the holes 70. Prior to the vacuum being released, each gripping head is closed over and grips a respective end region of the handle strip. The gripping heads are then retracted to pull the end portions 74 fully through the holes 70 and to straighten the handle pattern piece whereupon the gripping heads 82 are opened. As the handle strip straightens, it reaches a position where the reduced width regions 72 automatically locate at the centre of the holes 70 whereupon the gripping heads 82 are opened.

In a variation of the transfer head, instead of, or in addition to, the vacuum, retractable contact claws are used at the transfer head to temporarily clamp the handle strip against finger-shaped parts of the transfer head prior to the transfer head being brought close to the bag web to thread the handle strip end regions into the holes. The contact claws are released after the threading action is completed. In an alternative embodiment of the threading station, the handle strip web is end-delivered as shown in FIG. 12. A variation of the transfer head is used which threads the free end of the handle strip web into one of the pair of holes in the bag web. The handle strip is then detached from the handle strip web and the transfer head bends the detached handle strip to enable threading of the other end of the handle strip into the other of the pair of holes. The linking of the handle strip to the bag web is effected using a vacuum and/or gripping head arrangement similar to that described with reference to FIG. 13.

The bag web with the handle strip in place is then fed to a first heat sealing station. At the first heat sealing station, the end regions 74 which project through and lie adjacent the lower surface of the bag web 60 are tack sealed to the bag web. The tack seal serves to fix the bag web and handle strip in a proper disposition for subsequent processing. It also initiates a folding action in each part of the handle strip projecting through the spaced holes 70 to form folded portions. These folded portions are shown in finished form as elements 36 and 44 in FIG. 4. At a subsequent heat sealing station, the folded over portions are fully folded by a retractable plate arrangement and heat sealed against the parts of the handle strip located in the holes 70, so as to seal and reinforce the holes. As indicated with respect to FIGS. 4 and 5, the folded over portions provide a two-part reinforcing strip adjacent the holes 70 with marginal parts of the strip also bonded to the bag web at what will subsequently become the inside surface of the bag. A two-part heat sealing operation with ambient or accelerated cooling is used to create a strong bond and to limit heat build-up which might otherwise cause degradation of the thermoplastics material.

In the heat sealing operation, the heat sealing zone is made to extend over the full area of the folded material so that no part of the folded material is free. Any free part of the handle strip or reinforcing strip material is undesirable because it can be a source of weakness and a source of air and contaminant entry. It can also contribute to an overly bulky material which is undesirable especially if, at a later stage of bag formation, the panel containing the handle is to be folded to form a gusset area.

It is important in all bonding operations, whether by heat sealing or adhesive, to avoid channel leaks since these can be a source of entry of insects, air and moisture which can later attack and adulterate the contents of the bag if the contents are edible materials such as pet food. One source of channel leaks is wrinkling of the materials being bonded. In the case of thermoplastics, wrinkling and channel leaks are minimized by ensuring that a thermoplastics material is used which has good heat flow properties. For example, high heat flow can be obtained by increasing the elastomeric polythethylene content of a polyethylene layer, the regular polyethylene and elastomeric polyethylene forming a tailored co-polymer. However, the elastomeric content is not made so high as to adversely affect the machinability of the finish material or to render it unpleasantly tacky. A suitable percentage of elastomeric polyethylene is 23%.

The bag and handle embodiments of FIGS. 6 to 9 can be made using process steps which are similar to the process steps described above, but tailored, as will be understood by those skilled in the art, to the particular design of bag and handle arrangement.

The embodiments of the invention illustrated and described all relate to a bag in which the panel to which the handle is attached also functions as a gusset. It will be understood that the handle can be attached to any panel of the bag. The handle can, for example, be located in either side panel, either end panel or in a bottom panel at end 12 of the exemplary bag shown in FIGS. 1 to 3.

There have been described herein various embodiments of a bag and handle arrangement and manufacturing processes therefor, such arrangements and processes having features that distinguish the present invention from the prior art. It will be apparent to those skilled in the art that the bag and manufacture of the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A bag having a panel, the panel having an inner surface and an outer surface and a plurality of holes through the panel, a handle strip having a handle part thereof disposed adjacent the panel outer surface, and at least one reinforcing strip disposed adjacent the panel inner surface, areas of the handle strip and areas of the at least one reinforcing strip being sealed together through the holes.

2. A bag as claimed in claim 1, the handle strip and the at least one reinforcing strip each formed of a thermoplastics material, the handle strip and the reinforcing strip sealed together by heat sealing.

3. A bag as claimed in claim 1, the handle strip and the at least one reinforcing strip sealed together by a layer of adhesive.

4. A bag as claimed in claim 1, the sealed together areas of the handle strip and the at least one reinforcing strip fully closing the holes.

5. A bag as claimed in claim 2, the handle strip and the at least one reinforcing strip formed of a composite, layered material including a polyethylene-nylon-polyethylene sandwich structure.

6. A bag as claimed in claim 1, the panel having a pair of such holes, the handle strip having extensions at respective ends thereof, the extensions projecting through respective ones of the holes, each extension having a first portion and a second portion, the second portion folded onto, and sealed to, the first portion, the folded extensions forming respective ones of the reinforcing strips.

7. A bag as claimed in claim 6, at least a part of each of the folded extensions sealed to the panel inner face.

8. A bag as claimed in claim 6, the handle strip having parts of reduced width at locations where the strip projects through the respective holes, the width of the handle strip parts being substantially the same as the width of the holes.

9. A bag as claimed in claim 6, the holes having a shape, the shape being one of a circle, an oval, a slot and a D.

10. A bag as claimed in claim 1, the panel having a pair of such holes, the handle strip being of elongate form and having extensions at respective ends thereof the extensions projecting through respective ones of the holes, the at least one reinforcing strip comprising a single reinforcing strip extending between and at least partially covering, and sealed to, the extensions.

11. A bag as claimed in claim 10, the reinforcing strip and the extensions sealed to the panel inner face.

12. A bag as claimed in claim 1, the panel having a pair of such holes, the handle strip having extensions at respective ends thereof, each extension having a first portion immediately adjacent the handle part, which first portion includes one of the areas of the handle strip, and a second portion sealed to the panel outer face, the reinforcing strip being sealed to the panel inner face.

13. In the manufacture of a bag, a method of fitting a handle comprising forming a plurality of holes in bag web material, bringing a handle strip to the holes at one surface of the material, bringing a reinforcing strip to the holes at a reverse surface of the material, and sealing the handle strip to the reinforcing strip through the holes.

14. A method as claimed in claim 13, further comprising making the handle strip and the reinforcing strip of a thermoplastics material, and sealing the handle strip to the reinforcing strip by heat sealing.

15. A method as claimed in claim 14, further comprising sealing the reinforcing strip to the panel inner face adjacent the hole.

16. A method as claimed in claim 14, further comprising making a pair of such holes in the panel, inserting extensions at ends of the handle strip through respective ones of the holes from the one surface of the material to the reverse surface of the material, folding the extensions to cover the respective holes, and heat sealing folded portions of the extensions to each other and to the reverse surface of the panel to form spaced elements of the reinforcing strip.

17. A method as claimed in claim 16, further comprising forming the handle strip with regions of reduced width substantially equal to the width of the holes.

18. A method as claimed in claim 16, further comprising forming the holes in a predetermined shape, the shape being one of a circle, an oval, a slot and a D.
